(19) United States
(12) Patent Application Publication
(10) Pub. No.: US 2026/0143549 A1
(43) Pub. Date: May 21, 2026

(54) DEDICATED SYSTEM INFORMATION DELIVERY WITH MULTIPLE CENTRAL UNITS AND SHARED DISTRIBUTED UNIT

(71) Applicant: QUALCOMM Incorporated, San Diego, CA (US)

(72) Inventors: Shankar KRISHNAN, Poway, CA (US); Karl Georg HAMPEL, Jersey City, NJ (US); Gavin Bernard HORN, La Jolla, CA (US); Naeem AKL, BRIDGEWATER, NJ (US); Ozcan OZTURK, San Diego, CA (US); Karthika PALADUGU, Hyderabad (IN)

(21) Appl. No.: 18/949,975

(22) Filed: Nov. 15, 2024

(51) Int. Cl. H04W 76/20; H04W 24/02; H04W 80/02

(52) U.S. Cl. CPC H04W 76/20; H04W 24/02; H04W 80/02

(57) ABSTRACT

This disclosure provides systems, methods and apparatuses for management of system information with multiple central units (CUs) and shared distributed unit (DU). A CU is configured to obtain, from a user equipment (UE) having a radio resource control (RRC) connection with the CU, a request to transmit one or more system information blocks (SIBs) to the UE. The CU obtains, from one or more other network entities, the one or more SIBs. The CU requests, after obtaining the one or more SIBs, a second network entity to transmit the one or more SIBs to the UE. The second network entity may be a DU that transmits the one or more SIBS to the UE via broadcast or dedicated signaling.

### TECHNICAL FIELD

The present disclosure relates to wireless communications including dedicated system information delivery with dedicated system information (SI) delivery with multiple central units (CU) and shared distributed unit (DU).

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (such as with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard.

### SUMMARY

The systems, methods and devices of this disclosure each have several innovative aspects, no single one of which is solely responsible for the desirable attributes disclosed herein.

In some aspects, the techniques described herein relate to an apparatus for wireless communication, including: one or more memories storing computer-executable instructions; and one or more processors coupled with the one or more memories and configured to execute the computer-executable instructions, individually or in combination, to cause the apparatus to: obtain, from a user equipment (UE) having a radio resource control (RRC) connection with the apparatus, a request to transmit one or more system information blocks (SIBs) to the UE; obtain, from one or more other network entities, the one or more SIBs; and request, after obtaining the one or more SIBs, a second network entity to transmit the one or more SIBs to the UE.

In some aspects, the techniques described herein relate to an apparatus for wireless communication, including: one or more memories storing computer-executable instructions; and one or more processors coupled with the one or more memories and configured to execute the computer-executable instructions, individually or in combination, to cause the apparatus to: obtain, from a user equipment (UE) having a radio resource control (RRC) connection with a second network entity that is different than a primary CU of the apparatus, a request to transmit one or more system information blocks (SIBs) to the UE; output the request to the second network entity; obtain, from the second network entity, an indication to transmit the one or more requested SIBs to the UE; and output one or more messages including the requested SIBs for transmission to the UE.

In some aspects, the techniques described herein relate to an apparatus for wireless communication, including: one or more memories storing computer-executable instructions; and one or more processors coupled with the one or more memories and configured to execute the computer-executable instructions, individually or in combination, to cause the apparatus to: output for transmission to a first network entity, a request for one or more system information blocks (SIBs), wherein the apparatus has a radio resource control (RRC) connection with a second network entity that is not a primary central unit for the first network entity; and obtain the one or more SIBs from the second network entity via dedicated signaling associated with the apparatus.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a diagram illustrating an example of a wireless communications system including an access network.

FIG. 2A is a diagram illustrating an example of a first frame.

FIG. 2B is a diagram illustrating an example of DL channels within a subframe.

FIG. 2C is a diagram illustrating an example of a second frame.

FIG. 2D is a diagram illustrating an example of a subframe.

FIG. 3 is a diagram illustrating an example of a base station (BS) and user equipment (UE) in an access network.

FIG. 4 is a diagram illustrating an example disaggregated base station architecture with multiple central units (CU).

FIG. 5 is a diagram of an example scenario for providing system information from multiple CUs.

FIG. 6 is a message diagram showing various messages to facilitate delivery of system information from multiple sources.

FIG. 7 is a conceptual data flow diagram illustrating the data flow between different means/components in an example network entity including a system information block (SIB) management component.

FIG. 8 is a conceptual data flow diagram illustrating the data flow between different means/components in an example network entity including SIB delivery component.

FIG. 9 is a conceptual data flow diagram illustrating the data flow between different means/components in an example UE including a SIB demand component.

FIG. 10 is a flowchart of an example method for a wireless node such as a UE to request system information.

FIG. 11 is a flowchart of an example method for a wireless node such as a network entity to deliver system information from multiple network entities to a UE on demand.

FIG. 12 is a flowchart of an example method for a wireless node such as a network entity to manage system information from multiple network entities for delivery to a UE on demand.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. Some of the examples in this disclosure are based on wireless and wired local area network (LAN) communication according to the Institute of Electrical and Electronics Engineers (IEEE) 802.11 wireless standards, the IEEE 802.3 Ethernet standards, and the IEEE 1901 Powerline communication (PLC) standards. However, the described implementations may be implemented in any device, system or network that is capable of transmitting and receiving RF signals according to any of the wireless communication standards, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, 6G or further implementations thereof, technology.

In wireless communications, a network entity may generate system information that is then broadcast by a base station. In a 5G network with a split architecture, functionality may be divided between a distributed unit (DU) and a central unit (CU). The DU and the CU may each be responsible for generating and/or encoding certain system information blocks (SIBs) that include information relevant to the respective unit. For example, the DU may generate or encode SIBs 1, 10, 12, 13, 14, 15, 17, 18, 20, 22, 23, and 24, and the CU may generate or encode the remaining SIBs. The DU may provide a radio resource control (RRC) container to the CU with the encoded SIBs. For instance, the DU may send an F1 setup request and/or gNB-DU configuration update. The CU may schedule the transmission of the SIBs by providing all SIBs to the DU along with information such as a SIB type, an RRC container, value tag, area scope, system information area ID. For instance, the CU may transmit a F1 setup response, gNB-DU configuration update Ack, and/or gNB-CU configuration update. In some cases, a UE that has an RRC connection to a CU may request transmission of system information via an on demand system information request (DedicatedSIRequest) or via a RACH procedure indicating on demand system information (ODSI). The CU can control the DU to broadcast the requested system information. In some cases, a UE may be unable to receive system information via broadcast, and a dedicated SI delivery method may be used.

In a 6G network, a split architecture may include multiple CUs associated with a DU. For example, a DU may be associated with a primary CU that handles regular traffic. One or more secondary CUs may be special purpose CUs. For example, a secondary CU may be dedicated to traffic for reduced capability (RedCap) UEs. There also could be multiple CUs associated to a DU for load balancing purposes or as a hot standby in case of a CU failure. The multiple CUs might have different priorities/roles (e.g., primary or secondary) associated to a DU based on some policies or configuration. The presence of multiple CUs creates a potential conflict regarding responsibility for generation of system information.

In an aspect, the present disclosure provides techniques for delivery of system information from multiple sources. For instance, a secondary CU may be an anchor CU for a UE. That is, the UE may have an RRC connection with the secondary CU rather than the primary CU. For instance, a RedCap UE may have an RRC connection with a dedicated CU for RedCap UEs. The primary CU may still be responsible for providing the DU with SIBS to broadcast. The secondary-anchor CU, however, may be responsible for handling requests for on demand system information because the secondary-anchor CU may be responsible for the UE via the RRC connection. For instance, some SIBs that are particular to the operation of the secondary-anchor CU may be generated by the secondary-anchor CU and the UE may request those SIBS as ODSI. The secondary-anchor CU may also provide SIBs that are generated by other network entities. For instance, when the UE requests multiple SIBs, the secondary-anchor CU may obtain the SIBs that are not generated by the secondary-anchor CU from other network nodes via system information configuration requests. The secondary-anchor CU may have the DU deliver the SIBs via either broadcast or dedicated transmissions.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. The processor may include an interface or be coupled to an interface that can obtain or output signals. The processor may obtain signals via the interface and output signals via the interface. In some implementations, the interface may be a printed circuit board (PCB) transmission line. In some other implementations, the interface may include a wireless transmitter, a wireless transceiver, or a combination thereof. For example, the interface may include a radio frequency (RF) transceiver which can be implemented to receive or transmit signals, or both. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media, which may be referred to as non-transitory computer-readable media. Non-transitory computer-readable media may exclude transitory signals. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

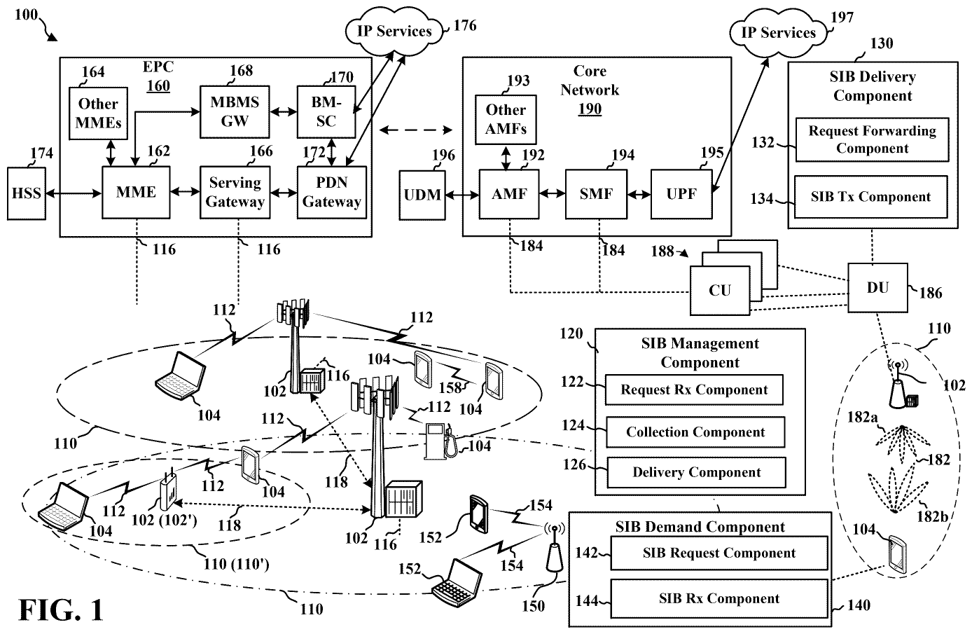

FIG. 1 is a diagram illustrating an example of a wireless communications system and an access network 100. The wireless communications system (also referred to as a wireless wide area network (WWAN)) includes wireless nodes such as base stations 102 and UEs 104, an Evolved Packet Core (EPC) 160, and another core network 190 (such as a 5G Core (5GC)). The base stations 102 may include macrocells (high power cellular base station) or small cells (low power cellular base station). The macrocells include base stations. The small cells include femtocells, picocells, and microcells. The small cells include femtocells, picocells, and microcells. The base stations 102 can be configured in a Disaggregated RAN (D-RAN) or Open RAN (O-RAN) architecture, where functionality is split between multiple units such as one or more central units (CUs) 188, one or more distributed units (DUs) 186, or a radio unit (RU) 180. Such architectures may be configured to utilize a protocol stack that is logically split between one or more units (such as one or more CUs and one or more DUs). In some aspects, the CUs 188 may be implemented within an edge RAN node, and in some aspects, one or more DUs 186 may be co-located with a CU 188, or may be geographically distributed throughout one or multiple RAN nodes. The DUs 186 may be implemented to communicate with one or more RUs 180.

In some implementations, one or more wireless nodes such as the UEs 104 include a SIB demand component 140 configured to request one or more SIBs via an on demand system information (ODSI) request. The SIB demand component 140 includes SIB request component 142 and a SIB Rx component 144. The SIB request component 142 is configured to output for transmission to a first network entity (e.g., the DU 186), a request for one or more requested system information blocks (SIBs). The UE 104 including the SIB demand component 140 has a radio resource control (RRC) connection with a second network entity (e.g., a CU 188) that is not a primary central unit for the first network entity.

In some implementations, one or more of the network entities such as a DU 186 includes a SIB delivery component 130 configured to deliver system information from multiple network entities to a UE 104. In particular, the SIB delivery component 130 may deliver system information in response to an ODSI request form a UE. The SIB delivery component 130 includes a request forwarding component 132 and a SIB transmission (Tx) component 134. The request forwarding component 132 is configured to obtain, from a UE 104 having a RRC connection with a second network entity (e.g., a CU 188) that is different than a primary CU of the DU 186, a request to transmit one or more SIBs to the UE 104. The request forwarding component 132 is also configured to output the request to the second network entity. The SIB Tx component 134 is configured to obtain, from the second network entity, an indication to transmit the one or more requested SIBs to the UE. The SIB Tx component 134 is also configured to output one or more messages including the requested SIBs for transmission to the UE.

In some implementations, one or more of the network entities such as a CU 188 includes a SIB management component 120 configured to determine SIBs from multiple network entities for transmission to a UE 104 in response to a request. The SIB management component 120 includes a request receiving (Rx) component 122, a collection component 124, and a delivery component 126. The request Rx component 122 is configured to obtain, from a UE 104 having a RRC connection with the CU 188, a request to transmit one or more SIBs to the UE 104. The collection component 124 is configured to obtain, from one or more other network entities, the one or more SIBs. The delivery component 126 is configured to request, after obtaining the one or more SIBs, a second network entity (e.g., DU 186) to transmit the one or more SIBs to the UE 104.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 116 (such as S1 interface), which may be wired or wireless. The base stations 102 configured for 5G NR (collectively referred to as Next Generation RAN (NG-RAN)) may interface with core network 190 through second backhaul links 184, which may be wired or wireless. In addition to other functions, the base stations 102 may perform one or more of the following functions: transfer of user data, radio channel ciphering and deciphering, integrity protection, header compression, mobility control functions (such as handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (such as through the EPC 160 or core network 190) with each other over third backhaul links 118 (such as X2 interface). The third backhaul links 118 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network also may include Home Evolved Node Bs (eNBs) (HeNBs), which may provide service to a restricted group known as a closed subscriber group (CSG). The communication links 112 between the base stations 102 and the UEs 104 may include UL (also referred to as reverse link) transmissions from a UE 104 to a base station 102 or DL (also referred to as forward link) transmissions from a base station 102 to a UE 104. The communication links 112 may use multiple-input and multiple-output (MIMO) antenna technology, including spatial multiplexing, beamforming, or transmit diversity. The communication links may be through one or more carriers. The base stations 102/UEs 104 may use spectrum up to Y MHz (such as 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (such as more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to or increase capacity of the access network.

A base station 102, whether a small cell 102′or a large cell (such as macro base station), may include an eNB, gNodeB (gNB), or other type of base station. Some base stations, such as gNB may operate in one or more frequency bands within the electromagnetic spectrum.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW radio frequency band have extremely high path loss and a short range. The mmW base station may utilize beamforming 182 with the UE 104 to compensate for the path loss and short range. For example, the base station 102 may use beamforming 182 to transmit beams 182a and the UE 104 may utilize beamforming 182 to transmit beams 182b.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, or other IP services.

The base station may include or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (such as a MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (such as a parking meter, gas pump, toaster, vehicles, heart monitor, etc.). The UE 104 also may be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the following description may be focused on 6G, the concepts described herein may be applicable to other similar areas, such as 5G NR, LTE, LTE-A, CDMA, GSM, and other wireless technologies including future wireless technologies.

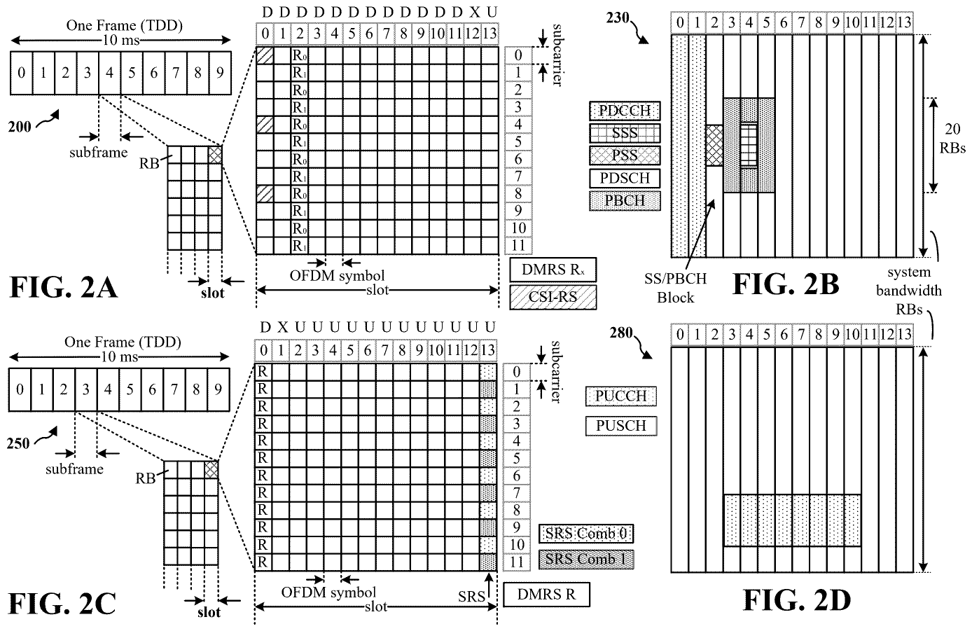

FIG. 2A is a diagram 200 illustrating an example of a first frame. FIG. 2B is a diagram 230 illustrating an example of DL channels within a subframe. FIG. 2C is a diagram 250 illustrating an example of a second frame. FIG. 2D is a diagram 280 illustrating an example of a subframe. The 5G NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. A subset of the total cell bandwidth of a cell is referred to as a Bandwidth Part (BWP) and bandwidth adaptation is achieved by configuring the UE with BWP(s) and telling the UE which of the configured BWPs is currently the active one. In an aspect, a narrow bandwidth part (NBWP) refers to a BWP having a bandwidth less than or equal to a maximum configurable bandwidth of a BWP. The bandwidth of the NBWP is less than the carrier system bandwidth.

In the examples provided by FIGS. 2A, 2C, the 5G NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure or different channels. A frame (10 milliseconds (ms)) may be divided into 10 equally sized subframes (1 ms). Each subframe may include one or more time slots. Subframes also may include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μis the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (μs).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DMRS) (indicated as Rx for one particular configuration, where 100× is the port number, but other DM-RS configurations are possible) and channel state information reference signals (CSI-RS) for channel estimation at the UE. The RS also may include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a L1 identity. A secondary synchronization signal (SSS) may be within symbol 4 of particular subframes of a frame. The SSS is used by a UE to determine a L1 cell identity group number and radio frame timing. Based on the L1 identity and the L1 cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), or UCI.

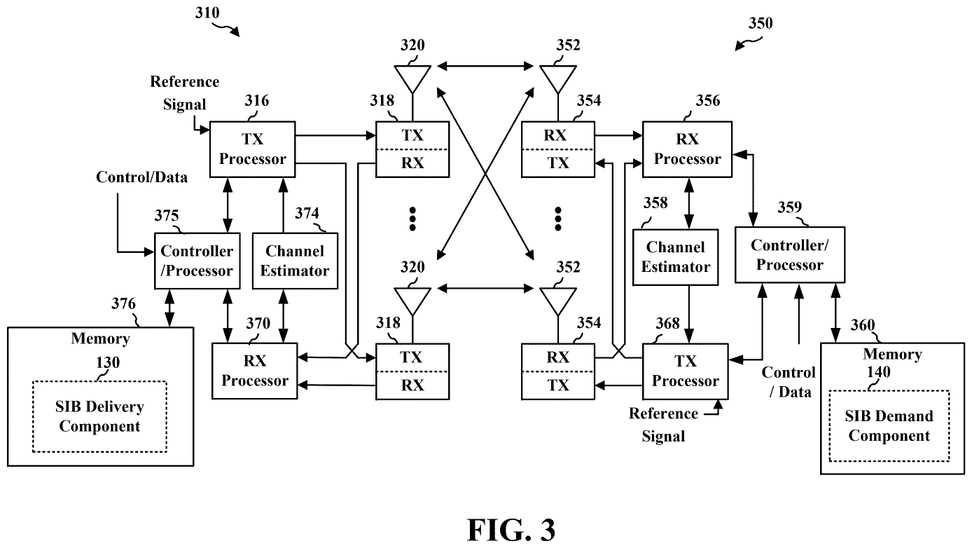

FIG. 3 is a diagram of an example of a base station 310 and a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (such as MIB, SIBs), RRC connection control (such as RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (such as binary phase-shift keying (BPSK), quadrature phase-shift keying (QPSK), M-phase-shift keying (M-PSK), M-quadrature amplitude modulation (M-QAM)). The coded and modulated symbols may be split into parallel streams. Each stream may be mapped to an OFDM subcarrier, multiplexed with a reference signal (such as a pilot) in the time or frequency domain, and combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal or channel condition feedback transmitted by the UE 350. Each spatial stream may be provided to a different antenna 320 via a separate transmitter 318TX. Each transmitter 318TX may modulate an RF carrier with a respective spatial stream for transmission. In a split architecture, the transmitters/receivers 318 may be located in an RU 180, and the Tx processor 316, channel estimator 374, controller/processor 375, and Rx processor 370 may be located in a DU 186.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are decoded and deinterleaved to recover the data and control signals that were originally transmitted by the base station 310 on the physical channel. The data and control signals are provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK or NACK protocol to support HARQ operations.

Similar to the functionality described in connection with the DL transmission by the base station 310, the controller/processor 359 provides RRC layer functionality associated with system information (such as MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK or NACK protocol to support HARQ operations.

At least one of the TX processor 368, the RX processor 356, and the controller/processor 359 may be configured to perform aspects in connection with the SIB demand component 140 of FIG. 1. For example, the memory 360 may include executable instructions defining the SIB demand component 140. The TX processor 368, the RX processor 356, and/or the controller/processor 359 may be configured to execute the SIB demand component 140.

At least one of the TX processor 316, the RX processor 370, and the controller/processor 375 may be configured to perform aspects in connection with the SIB delivery component 130 of FIG. 1. For example, the memory 376 may include executable instructions defining the interference component 120. The TX processor 316, the RX processor 370, and/or the controller/processor 375 may be configured to execute the SIB delivery component 130.

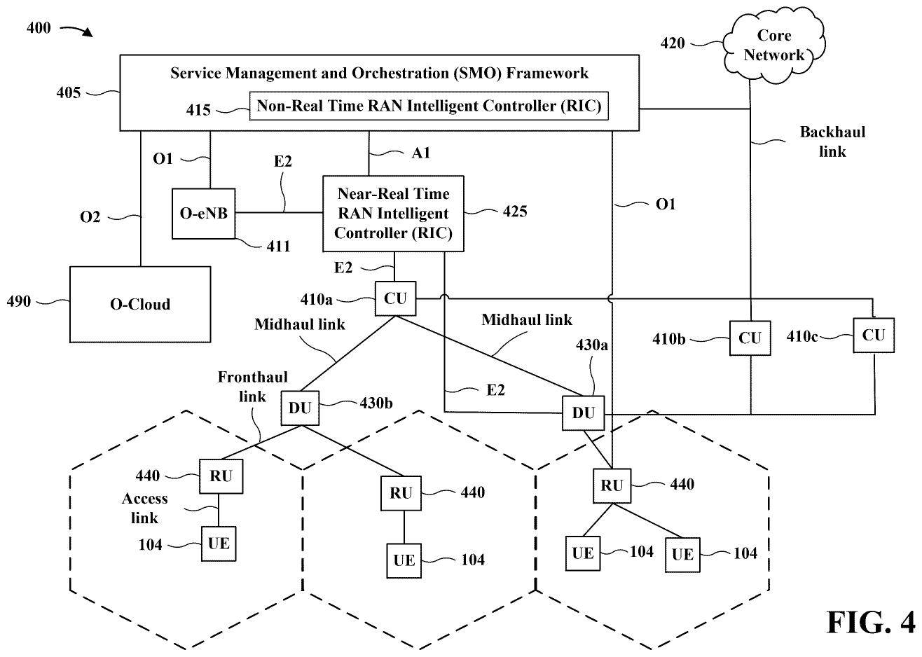

FIG. 4 is a diagram illustrating an example disaggregated base station 400 architecture. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 via respective midhaul links, such as an F1 interface. The DUs 430 may communicate with one or more radio units (RUs) 440 via respective fronthaul links. The RUs 440 may communicate with respective UEs 104 via one or more radio frequency (RF) access links. In some implementations, the UE 104 may be simultaneously served by multiple RUs 440.

Each of the units, i.e., the CUs 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via O1) or via creation of RAN management policies (such as A1 policies).

In an aspect, a 6G split architecture may include a multi-CU shared DU. That is, multiple CUs 410 (e.g., CUs 410a, 410b, 410c) may be allowed to control a DU 430a. In order to prevent conflicts, one CU 410 (e.g., CU 410a) may be designated as a primary CU for the DU. For instance, the DU 430a may prioritize the CUs 410 such that in the event of a conflict, the higher priority CU (e.g., the primary CU 410a) controls. In some implementations, the radio resource control (RRC) layer may be located in the CU 410. A specific UE 104 may establish an RRC connection with a CU 410. The CU 410 with the RRC connection to a UE may be referred to as the anchor CU of the UE. Accordingly, as used herein with respect to a CU, the terms primary and secondary refer to the priority of the CU for a specific DU, and the term anchor refers to the endpoint of an RRC connection with a UE.

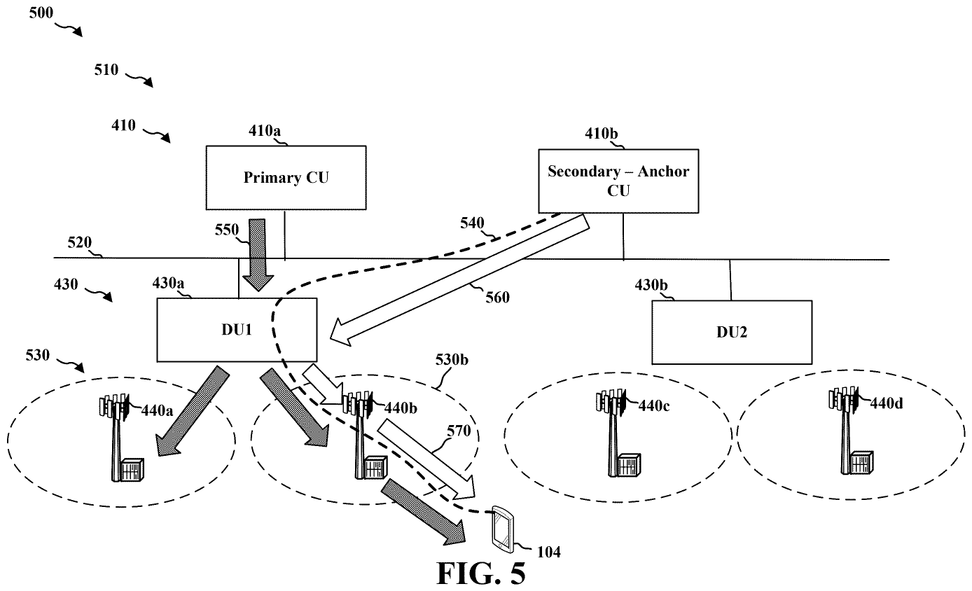

FIG. 5 is a diagram 500 of an example scenario for providing system information from multiple CUs. As illustrated, an example radio access network 510 includes two CUs 410a and 410b and two DUs 430a and 430b. The CUs 410 and DUs 430 may communicate with each other via a backhaul 520. The DUs 430 may communicate with RUs 440, for example, by sending and receiving in-phase and quadrature (IQ) samples corresponding to transmissions within cells 530.

For simplicity, a single UE 104 is illustrated. The UE 104 may be located within a cell 530b that is controlled by DU 430a. The DU 430a may have CU 410a designated as the primary CU and the CU 410b designated as a secondary CU. The UE 104 may establish an RRC connection 540 with the secondary CU 410b. For instance, the CU 410b may be a special purpose CU that handles traffic for a particular type of UE or a particular service. Accordingly, because the UE 104 has an RRC connection with the CU 410b, the CU 410b may be considered the anchor CU for the UE 104. The CU 410-b may be referred to as a secondary-anchor CU.

In an aspect, different network entities may be responsible for generating and/or encoding SIBS. For example, the DU may generate or encode SIBs 1, 10, 12, 13, 14, 15, 17, 18, 20, 22, 23, and 24, and the CU may generate or encode the remaining SIBs. Each network entity may generate system information that is relevant for that network entity. For instance, SIB1 includes scheduling information for the other SIBs, and the DU is responsible for transmitting the SIBs according to the schedule, so the DU is responsible for generating SIB1. In some implementations, the primary CU 410a for the DU 430a may determine the SIBs that are initially broadcast by the DU 430a. For instance, the DU 430a may provide the DU-generated SIBs to the CU 410a, and the CU 410a may provide a configuration 550 with all of the SIBs for the DU 430a to broadcast. The DU 430a may transmit the broadcast SIBs via the RUs 440, and the UE 104 may receive the broadcast SIBs.

An on-demand system information (ODSI) request may be initiated by a UE 104 when the UE 104 is missing system information. For example, reception of a SIB message at the UE 104 may have failed, or a particular SIB message is not scheduled or has a long periodicity. For instance, as an amount of system information increases but the resources for transmitting system information remain the same, some SIB messages may be transmitted with a greater periodicity. The UE may initiate an ODSI request by transmitting an RRC message (e.g., DedicatedSIRequest), or via a RACH procedure (e.g., Msg1/Msg3). The ODSI request may include a list of requested SIBs.

The anchor CU (e.g., CU 410b) may be responsible for handling an ODSI request. The ODSI request may be directed to the anchor CU 410b via the RRC message or RACH procedure, even if the anchor CU 410b is not the primary CU. The anchor CU may obtain the requested SIBs. In some cases, the requested SIBs may be SIBs generated by the anchor CU 410b. For example, in the case of a special purpose CU, there may be additional system information that is not generated by the primary CU 410a. In other cases, the requested SIBs may be generated by the primary CU 410a or the DU 430a, but the UE may not have received the SIBs. The anchor CU 410b may obtain the requested SIBs from the other network entities via the backhaul 520. The anchor CU 410 b may send a configuration 560 of SIBs to the DU 430a. The DU 430a may transmit the configured SIBs to the UE 104. In some implementations, the DU 430a may broadcast the SIBs in the configuration 560. In some implementations, the DU 430a may use dedicated signaling for the UE 104 to transmit the SIBs in the configuration 560 to the UE 104. Accordingly, the UE 104 may receive the requested SIBs.

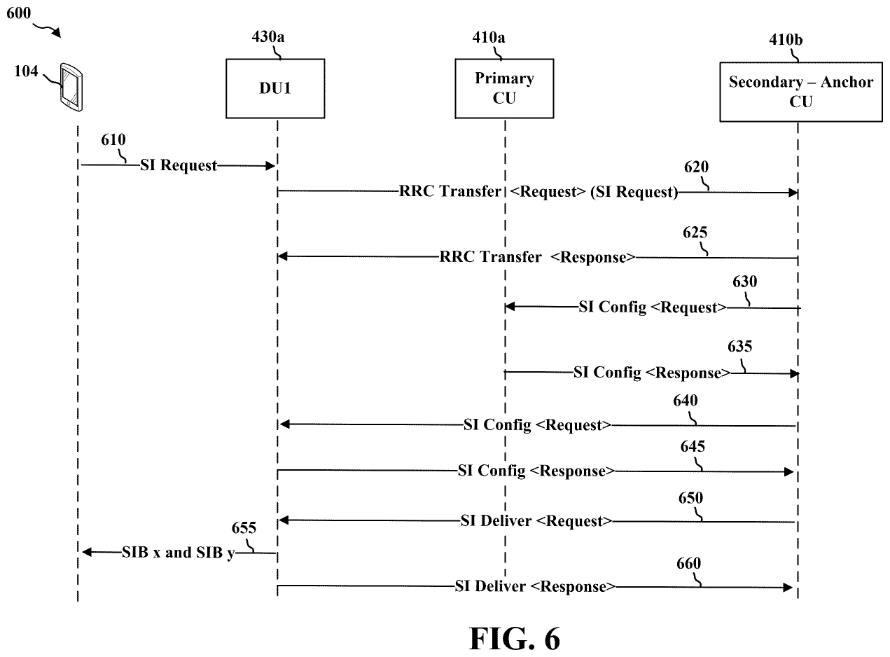

FIG. 6 is a message diagram 600 showing various messages to facilitate delivery of system information from multiple sources. A UE may communicate with a RAN including network entities such as a DU 430a, a primary CU 410a, and a secondary-anchor CU 410b. The DU 430a may include an RU 440 or transmit and receive via one or more separate RU 440. In either case, the RU 440 is not shown for simplicity.

A UE 104 may output a SI request 610. The SI request 610 may indicate one or more SIBs that the UE 104 is requesting the RAN to send.

The DU 430a may output an RRC transfer request 620 to transfer the SI request 610 to the anchor CU for the UE (i.e., secondary-anchor CU 410b). The secondary-anchor CU 410b may output an RRC transfer response 625 to acknowledge the RRC transfer request 620.

The secondary-anchor CU 410b may determine the network entity associated with each requested SIB. For example, the secondary-anchor CU 410b may identify DU-SIBs as being associated with the DU 430a. For CU-SIBs, the secondary-anchor CU 410b may determine whether the secondary-anchor CU 410b is configured to generate the requested SIB. If the secondary-anchor CU 410b does not generate the requested SIB, the secondary-anchor CU 410b may identify another network entity that generates the requested SIB. In some implementations, the secondary-anchor CU 410b may identify the primary CU 410a based information from the DU 430a (e.g., while establishing the RRC connection or in a separate message). In some implementations, the secondary-anchor CU 410b may discover the primary CU 410a via a network repository function (NRF) or other discovery service. In some implementations, the secondary-anchor CU 410b may identify a network function or service that is responsible for generating the one or more SIBs.

The secondary-anchor CU 410b may obtain the requested SIBs from the identified network entities. For example, the secondary-anchor CU 410b may output a SI config request 630 to the primary CU 410a. The primary CU 410a may respond with a SI config response 635. The SI config response 635 may include a configuration of the requested SIB such as the values of the parameters of the SIB, or may include an encoded SIB. As another example, the secondary-anchor CU 410b may output an SI config request 640 to the DU 430a. The DU 430a may respond with a SI config response 645. The SI config response may include an encoded SIB or an indication that the DU 430a can transmit the requested SIB.

The secondary-anchor CU 410b may output a SI deliver request 650 to the DU 430a. The SI deliver request 650 may include encoded SIB messages for the DU 430 to transmit or an indication of SIB messages that the DU 430 has stored. In some implementations, the SI deliver request 650 is a request for the DU 430a to transmit dedicated signaling to the UE based on an identifier of the UE, a system information type, and cell or beam identifier where the SIBs are to be transmitted. For example, the dedicated signaling may include RRC signaling, dedicated L2 signaling (i.e., DL MAC-CE), or dedicated L1 signaling (e.g., DCI). In some implementations, the SI deliver request 650 is a request for the DU 430a to broadcast the one or more requested SIBs in a list of cells or beams or areas. The DU 430a then outputs the requested SIBs 655 for transmission to the UE 104. In some implementations, the DU 430a may respond to the secondary-anchor CU 410b with a SI deliver response indicating whether the SIBs 655 were successfully delivered.

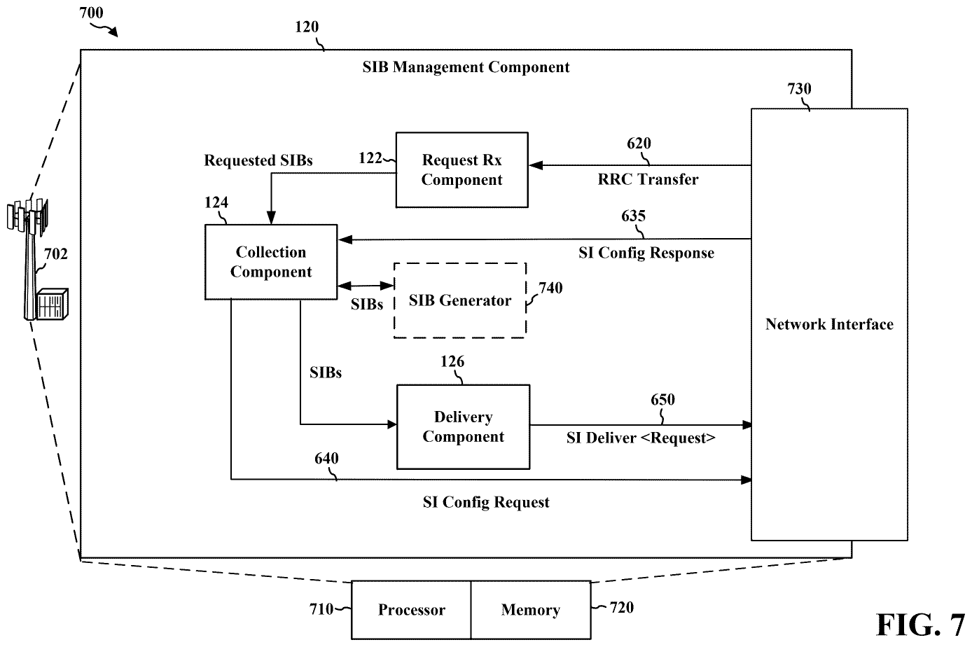

FIG. 7 is a conceptual data flow diagram 700 illustrating the data flow between different means/components in an example network entity 702 including a SIB management component 120. For example, the network entity 702 may be an example of a network node such as the base station 102 (FIG. 1) including the SIB management component 120. In some implementations, the SIB management component 120 may be implemented by the memory 376 and the TX processor 316, the RX processor 370, and/or the controller/processor 375 of FIG. 3. For example, the memory 376 may store executable instructions defining the SIB management component 120 and the TX processor 316, the RX processor 370, and/or the controller/processor 375 may execute the instructions. In other implementations, the SIB management component 120 may be implemented on computing resources including one or more processors 710 and one or more memories 720. For example, the SIB management component 120 may be implemented on a virtual CU in a datacenter.

The SIB management component 120 may be connected to a network interface 730. For example, the network interface 730 may be an Ethernet interface that provides a physical layer connection that carries Internet protocol (IP) packets to other network entities. The SIB management component 120 may be configured with APIs for communicating with other network entities. For instance, the SIB management component 120 may communicate via one or more of a point to point interface or a Service Based Interface (SBI).

As discussed with respect to FIG. 1, the SIB management component 120 may include the request Rx component 122, the collection component 124, and the delivery component 126.

The network interface 730 may receive messages from other network entities. For example, the network interface 730 may receive the RRC transfer request 620, the SI config response 635, 645, or the SI deliver response 660. The network interface 730 may output the RRC transfer request 620 to the request Rx component 122 and output the SI config response 635, 645 to the collection component 124.

The request Rx component 122 may obtain the RRC transfer request 620 from the network interface 730. The request Rx component 122 may parse the SI request 610 with the RRC transfer request 620 to determine the SIBs requested by the UE 104. The request Rx component 122 may output the requested SIBs to the collection component 124.

The collection component 124 may obtain the requested SIBs from the request Rx component 122. The collection component 122 may determine a network entity responsible for each requested SIB. For instance, the collection component may be configured with a mapping from SIB numbers to network entity type. The collection component may then determine the responsible instance of the network entity type for the UE. The SIB management component 120 at the secondary-anchor CU 410b may include a SIB generator 740 configured to generate SIBs specific to the secondary-anchor CU 410b. For instance, if the secondary-anchor CU 410b provides a particular service, the SIB generator 740 may generate the SIBs that define parameters for the service. In contrast, for more general functionality such as mobility information or GPS/UTC time information, the primary CU 410a for the DU 430a may be responsible for the SIBs. In some implementations, the collection component 124 may obtain an identity of the network entity responsible for the requested SIBs from the DU 430a that forwarded the SI request, from a network repository function (NRF), or from another network function. For instance, the identity can be the fully qualified domain name (FQDN), IP address, or a unique identification number. The identity may be used in communications with the network entity. Further, the DU 430a may be responsible for DU-SIBs. The collection component 124 may output a SI config request 630, 640 to each other network entity that is responsible for a requested SIB.

The collection component 124 may receive the SI config response 635, 645 from the other network entities (e.g., primary CU 410a and DU 430a). The collection component 124 may forward the received SIBs and any locally generated SIBs to the delivery component 126.

The delivery component 126 may obtain SIBs from the collection component 124. The delivery component 126 is configured to output a SI deliver request 650 to the DU 130a. For example, the delivery component 126 may output the SI deliver request 650 for transmission via the network interface 730.

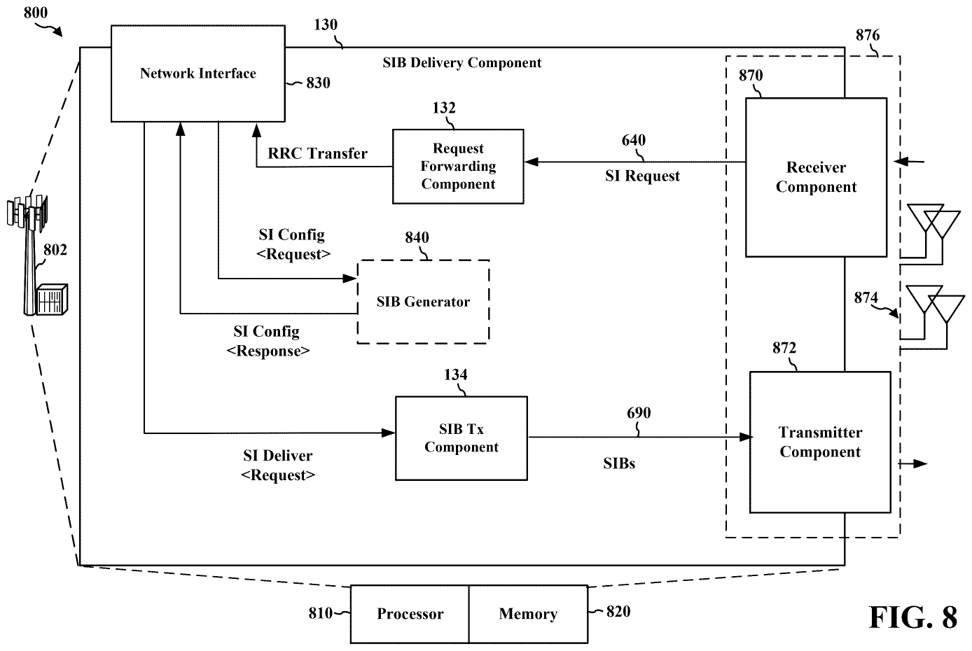

FIG. 8 is a conceptual data flow diagram 800 illustrating the data flow between different means/components in an example network entity 802 including a SIB delivery component 130. For example, the network entity 802 may be an example of a network node such as the base station 102 (FIG. 1) including the SIB delivery component 130. In some implementations, the SIB delivery component 120 may be implemented by the memory 376 and the TX processor 316, the RX processor 370, and/or the controller/processor 375 of FIG. 3. For example, the memory 376 may store executable instructions defining the SIB management component 120 and the TX processor 316, the RX processor 370, and/or the controller/processor 375 may execute the instructions. In other implementations, the SIB management component 120 may be implemented on computing resources including one or more processors 810 and one or more memories 820. For example, the SIB delivery component 120 may be implemented on a virtual DU in a datacenter.

The network entity 802 may include a receiver component 870, which may include, for example, a radio frequency (RF) receiver for receiving the signals described herein. The network entity 802 may include a transmitter component 872, which may include, for example, an RF transmitter for transmitting the signals described herein. The transmitter component 872 may output RF signals to one or more antennas 874. In an aspect, the receiver component 870 and the transmitter component 872 may be co-located in a transceiver 876, which may correspond to the TX/RX 318 in FIG. 3. The network entity 802 may include a network interface 830, which may be similar to the network interface 730 discussed above with respect to the SIB management component 120.

As discussed above, the SIB delivery component 130 may include the request forwarding component 132 and the SIB Tx component 134. The SIB delivery component 130 may optionally include a SIB generator 840.

The receiver component 870 is configured to receive signals from a UE 104. For example, the receiver component 970 may receive the SI request 610. The receiver component 870 may output the SI request 610 to the request forwarding component 132.

The request forwarding component 132 may obtain a SI request 610 from the receiver component 870. The request forwarding component 132 is configured to forward the SI request 610 to an anchor CU for the UE 104. For example, the request forwarding component 132 may store a mapping of UEs to CUs. For instance, the mapping may be based on a random access procedure in which a UE 104 establishes an RRC connection with the anchor CU. In some implementations, the SI request 610 may include an identifier of the anchor CU. The request forwarding component 132 may output an RRC transfer request 620 including the SI config request 640 for transmission to the anchor CU via the network interface 830.

In some implementations, the SIB delivery component 130 includes a SIB generator 840 that is configured to generate and encode SIBs based on the configuration of the DU 430a. The SIB generator 840 may store the generated SIBs. When a UE has requested a SIB associated with the DU 430a, the SIB delivery component 130 may receive a SI config request 640 via the network interface 830. The SI config request 640 may identify a type or number of a requested SIB. The SIB generator 840 may output a SIB config response 645 in response to the SI config request 640. The SIB config response 645 may include a SIB message for the requested SIB or an indication that the DU 430a can transmit the requested SIB.

The SIB Tx component 134 may obtain a SI deliver request 650 from a CU via the network interface 830. The SI deliver request 650 may indicate one or more SIBs that the network entity 802 should transmit to a UE. In some implementations, the SI deliver request 650 may indicate whether the network entity 802 should transmit the SIBs as a broadcast message or as dedicated signaling. For instance, a SI deliver request 650 for dedicated signaling may include an identifier of the UE, a system information type, and a cell or beam identifier where the SIBs are to be transmitted. A SI deliver request 650 for a broadcast transmission may include a list of cells, beams, or areas. The SIB Tx component 134 may output the requested SIBs for transmission via the transceiver 876 as indicated in the SI deliver request 650. In some implementations, the SIB Tx component 134 may output the SI deliver response 660 to the CU indicating whether delivery of the SIBs to the UE was successful.

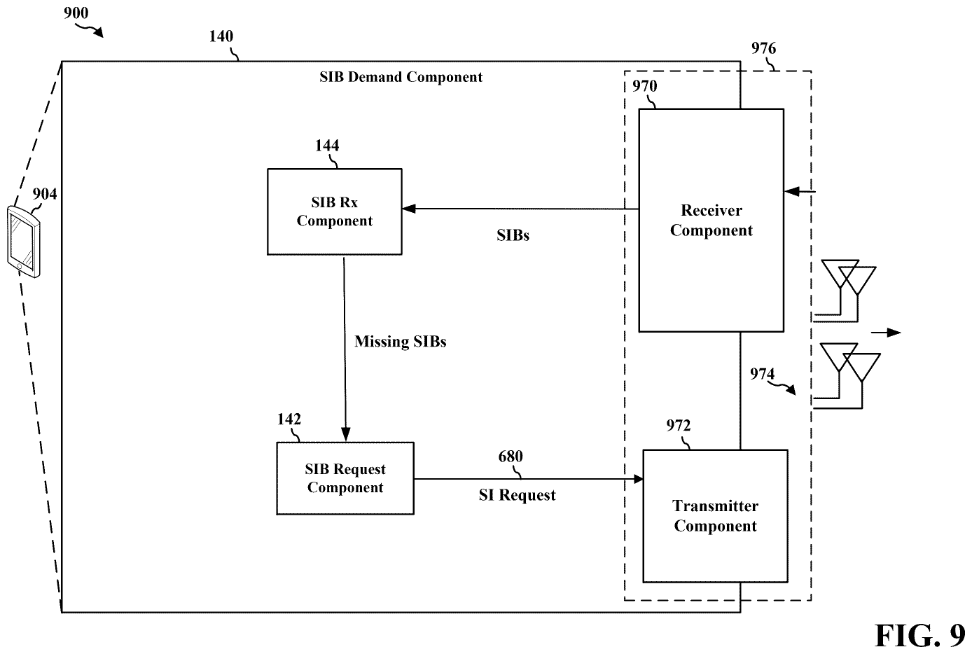

FIG. 9 is a conceptual data flow diagram 900 illustrating the data flow between different means/components in an example UE 904 including a SIB demand component 140. For example, the UE 904 may be an example of a wireless node such as the UE 104 (FIG. 1) including the SIB demand component 140. The SIB demand component 140 may be implemented by the memory 360 and the TX processor 368, the RX processor 356, and/or the controller/processor 368 of FIG. 3. For example, the memory 360 may store executable instructions defining the SIB demand component 140 and the TX processor 368, the RX processor 356, and/or the controller/processor 359 may execute the instructions.

The UE 904 may include a receiver component 970, which may include, for example, a radio frequency (RF) receiver for receiving the signals described herein. The UE 904 may include a transmitter component 972, which may include, for example, an RF transmitter for transmitting the signals described herein. The transmitter component 972 may output RF signals to one or more antennas 974. In an aspect, the UE 904 and the transmitter component 972 may be co-located in a transceiver 976, which may correspond to the TX/RX 354 in FIG. 3.

As discussed with respect to FIG. 1, the SIB demand component 140 may include the SIB request component 142 and the SIB Rx component 142.

The receiver component 970 may receive signals from a network entity such as a base station 102. For example, the receiver component 970 may receive the SIBs 655. The receiver component 970 may output the SIBS 655 to the SIB Rx component 144.

The SIB Rx component 144 may obtain SIBs via the receiver component 970. For instance, the SIB Rx component 144 may initially receive a master information block and determine resources for receiving SIB1, which includes scheduling information for other SIB messages. The SIB Rx component 144 may receive the other SIB messages and determine whether any system information is missing. For example, the receiver component 970 may have failed to decode a SIB message, or the SIB message may not be scheduled or may be scheduled with a long periodicity. The SIB Rx component 144 may output a list of missing SIBs to the SIB request component 142. The SIB Rx component 144 may continue to monitor for broadcast SIBs, which may include the missing SIBs. The SIB Rx component 144 may also be configured to receive the missing SIBs on dedicated signaling such as an RRC message, a DL MAC-CE, or a DCI.

The SIB request component 142 may obtain the list of missing SIBs from the SIB Rx component 144. The SIB request component 142 may output a SI request 680 for transmission. The SI request 680 may be a dedicated uplink RRC message, an UL MAC-CE, or a physical layer indication. The SI request 680 may identify the missing SIBs.

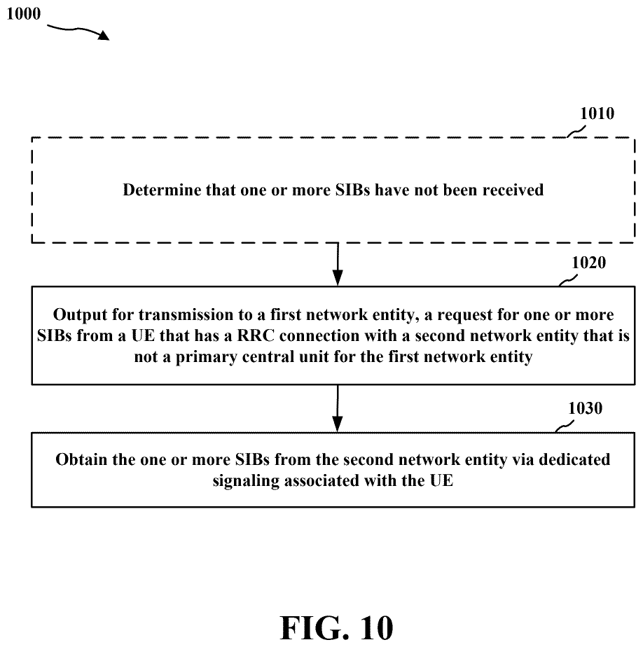

FIG. 10 is a flowchart of an example method 1000 for a wireless node such as a UE to request system information. The method 1000 may be performed by a UE (such as the UE 104, which may include the memory 360 and which may be the entire UE 104 or a component of the UE 104 such as the SIB demand component 140, TX processor 368, the RX processor 356, or the controller/processor 359). The method 1000 may be performed by the SIB demand component 140 in communication with the SIB delivery component 130 at a first network entity and a SIB management component 120 at a second network entity. Optional blocks are shown with dashed lines.

At block 1010, the method 1000 may optionally include determining that one or more SIBs have not been received. In some implementations, for example, the UE 104, the RX processor 356 or the controller/processor 359 may execute the SIB demand component 140 or the SIB Rx component 144 to determine that one or more SIBs have not been received. Accordingly, the UE 104, the RX processor 359, or the controller/processor 359 executing the SIB demand component 140 or the SIB Rx component 144 may provide means for determining that one or more SIBs have not been received.

At block 1020, the method 1000 includes outputting for transmission to a first network entity, a request for one or more SIBs from a UE that has a RRC connection with a second network entity that is not a primary central unit for the first network entity. In some implementations, for example, the UE 104, the TX processor 368 or the controller/processor 359 may execute the SIB demand component 140 or the SIB request component 142 to output for transmission to a first network entity, a request for one or more SIBs from a UE that has a RRC connection with a second network entity that is not a primary central unit for the first network entity. In some implementations, the request for one more SIBs is a dedicated uplink RRC message, an uplink MAC-CE, or a physical layer indication. Accordingly, the UE 104, the TX processor 368, or the controller/processor 359 executing the SIB demand component 140 or the SIB request component 142 may provide means for outputting for transmission to a first network entity, a request for one or more SIBs from a UE that has a RRC connection with a second network entity that is not a primary central unit for the first network entity.

At block 1030, the method 1000 includes obtaining the one or more SIBs from the second network entity via dedicated signaling associated with the UE. In some implementations, for example, the UE 104, the RX processor 356 or the controller/processor 359 may execute the SIB demand component 140 or the SIB Rx component 144 to obtain the one or more SIBs from the second network entity (e.g., secondary-anchor CU 410b) via dedicated signaling associated with the UE 104. Accordingly, the UE 104, the RX processor 356, or the controller/processor 359 executing the SIB demand component 140 or the SIB Rx component 144 may provide means for obtaining the one or more SIBs from the second network entity via dedicated signaling associated with the UE.

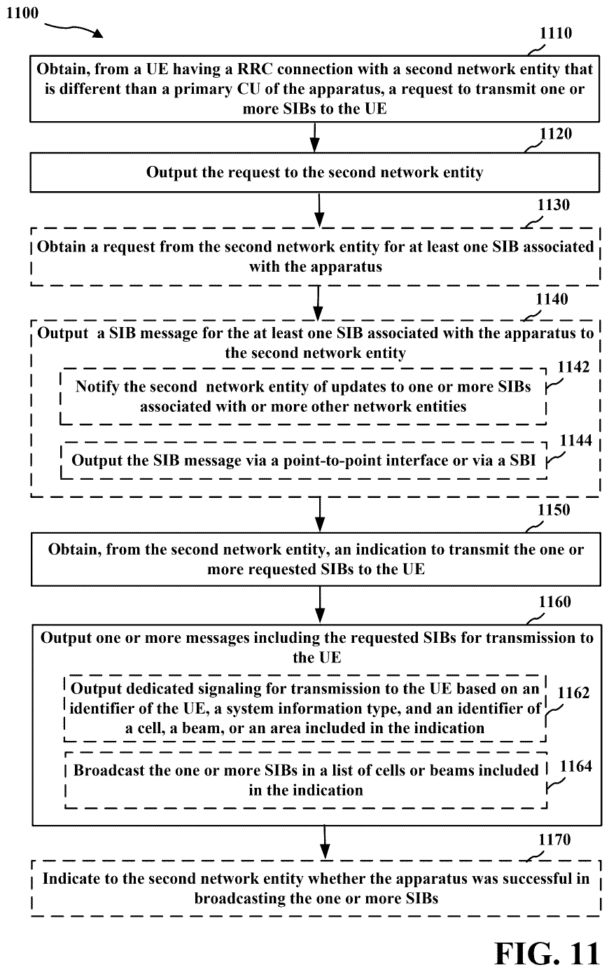

FIG. 11 is a flowchart of an example method 1100 for a wireless node such as a network entity to deliver system information from multiple network entities to a UE on demand. The method 1100 may be performed by a network entity 802 such as a base station (such as the base station 102, which may include the memory 376 and which may be the entire base station 102 or a component of the base station 102 such as a DU 430 including the SIB delivery component 130, TX processor 316, RX processor 370, or the controller/processor 375). The method 1100 may be performed by the SIB delivery component 130 in communication with the SIB demand component 140 at a UE and a SIB management component 120 at a CU. Optional blocks are shown with dashed lines.

At block 1110, the method 1100 includes obtaining from a UE having a RRC connection with a second network entity that is different than a primary CU of the apparatus, a request to transmit one or more SIBs to the UE. In some implementations, for example, the network entity 802, the RX processor 370, or the controller/processor 375 may execute the SIB delivery component 130 or the receiver component 870 to obtain from a UE 104 having a RRC connection 540 with a second network entity (e.g., secondary-anchor CU 410b) that is different than a primary CU (e.g., primary CU 410a) of the apparatus, a request (e.g., SI request 610) to transmit one or more SIBs to the UE. Accordingly, the network entity 802, the RX processor 370, or the controller/processor 375 executing the SIB delivery component 130 or the receiver component 870 may provide means for obtaining from a UE having a RRC connection with a second network entity that is different than a primary CU of the apparatus, a request to transmit one or more SIBs to the UE.

At block 1120, the method 1100 includes outputting the request to the second network entity. In some implementations, for example, the network entity 802, the TX processor 316, or the controller/processor 375 may execute the SIB delivery component 130 or the network interface 830 to output the request to the second network entity. Accordingly, the network entity 802, the Tx processor 316, or the controller/processor 375 executing the SIB delivery component 130 or the network interface 830 may provide means for outputting the request to the second network entity.

At block 1130, the method 1100 may optionally include obtaining a request from the second network entity for at least one SIB associated with the apparatus. In some implementations, for example, the network entity 802, the RX processor 370, or the controller/processor 375 may execute the SIB delivery component 130 or the network interface 830 to obtain a request from the second network entity for at least one SIB associated with the apparatus. Accordingly, the network entity 802, the RX processor 370, or the controller/processor 375 executing the SIB delivery component 130 or the network interface 830 may provide means for obtaining a request from the second network entity for at least one SIB associated with the apparatus.

At block 1140, the method 1100 may optionally include outputting a SIB message for the at least one SIB associated with the apparatus to the second network entity. In some implementations, for example, the network entity 802, the Tx processor 316, or the controller/processor 375 may execute the SIB delivery component 130 or the SIB generator 840 to output a SIB message for the at least one SIB associated with the apparatus to the second network entity. In some implementations, for example, at sub-block 1142 the block 1140 may optionally include notifying the second network entity of updates to one or more SIBs associated with one or more other network entities. In some implementations, for example, at sub-block 1144 the block 1140 may optionally include outputting the SIB message via a point-to-point interface or via a SBI. Accordingly, the network entity 802, the TX processor 316, or the controller/processor 375 executing SIB delivery component 130 or the network interface 830 may provide means for outputting a SIB message for the at least one SIB associated with the apparatus to the second network entity.

At block 1150, the method 1100 includes obtaining, from the second network entity, an indication to transmit the one or more requested SIBs to the UE. In some implementations, for example, the network entity 802, the RX processor 370, or the controller/processor 375 may execute the SIB delivery component 130 or the network interface 830 to obtain, from the second network entity, an indication to transmit the one or more requested SIBs to the UE. Accordingly, the network entity 802, the RX processor 370, or the controller/processor 375 executing the SIB delivery component 130 or the network interface 830 may provide means for obtaining, from the second network entity, an indication to transmit the one or more requested SIBs to the UE.

At block 1160, the method 1100 includes outputting one or more messages including the requested SIBs for transmission to the UE. In some implementations, for example, the network entity 802, the TX processor 316, or the controller/processor 375 may execute the SIB delivery component 130 or the SIB Tx component 134 to output one or more messages including the requested SIBs for transmission to the UE. In some implementations, at sub-block 1162, the block 1160 may optionally include outputting dedicated signaling for transmission to the UE based on an identifier of the UE, a system information type, and an identifier of a cell, a beam, or an area included in the indication. In some implementations, at sub-block 1164, the block 1160 may optionally include broadcasting the one or more SIBs in a list of cells or beams included in the indication. Accordingly, the network entity 802, the Tx processor 316, or the controller/processor 375 executing the SIB delivery component 130 or the SIB Tx component may provide means for outputting one or more messages including the requested SIBs for transmission to the UE.

At block 1170, the method 1100 may optionally include indicating to the second network entity whether the apparatus was successful in broadcasting the one or more SIBs. In some implementations, for example, the network entity 802, the TX processor 316, or the controller/processor 375 may execute the SIB delivery component 130 or the network interface 830 to indicate to the second network entity whether the apparatus was successful in broadcasting the one or more SIBs. For instance, the SIB delivery component may output the SI deliver response 660. Accordingly, the network entity 802, the Tx processor 316, or the controller/processor 375 executing the SIB delivery component 130 or the network interface 830 may provide means for indicating to the second network entity whether the apparatus was successful in broadcasting the one or more SIBs.

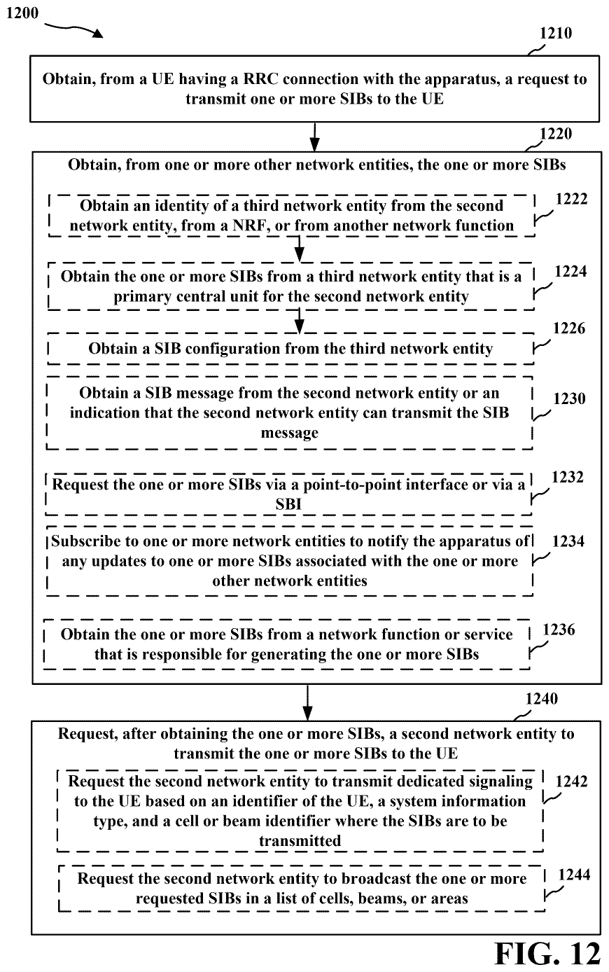

FIG. 12 is a flowchart of an example method 1200 for a wireless node such as a network entity to manage system information from multiple network entities for delivery to a UE on demand. The method 1200 may be performed by a network entity 702 such as a base station (such as the base station 102, which may include the memory 376 and which may be the entire base station 102 or a component of the base station 102 such as a CU 410 including the SIB management component 120, the processor 710, and the memory 720). The method 1100 may be performed by the SIB management component 120 in communication with the SIB demand component 140 at a UE and a SIB delivery component 130 at a DU. Optional blocks are shown with dashed lines.

At block 1210, the method 1200 includes obtaining, from a UE having a RRC connection with the apparatus, a request to transmit one or more SIBs to the UE. In some implementations, for example, the network entity 702 and/or the processor 710 may execute the SIB management component 120 or the request Rx component 122 to obtain from a UE having a RRC connection with the apparatus, a request to transmit one or more SIBs to the UE. For instance, the request Rx component 122 may receive the RRC transfer request 620 including the SI request 610 via the network interface 730. Accordingly, the network entity 802 and/or the processor 710 executing the SIB management component 120 or the request Rx component 122 may provide means for obtaining, from a UE having a RRC connection with the apparatus, a request to transmit one or more SIBs to the UE.

At block 1220, the method 1200 includes obtaining, from one or more other network entities, the one or more SIBs. In some implementations, for example, the network entity 702 and/or the processor 710 may execute the SIB management component 120 or the collection component 124 to obtain, from one or more other network entities, the one or more SIBs.

In some implementations, the collection component 124 may obtain the one or more SIBs from a third network entity that is the primary CU (e.g., primary CU 410a) for the second network entity (e.g., DU 430 a). For instance, at sub-block 1222, the block 1220 may optionally include obtaining an identity of the third network entity from the second network entity, from a NRF, or from another network function. At sub-block 1224, the block 1220 may optionally include obtaining the one or more SIBs from the third network entity that is a primary central unit for the second network entity. For instance, the collection component 124 may obtain the SIBs via an SI config request 630 and SI config response 635 communicated via the network interface 730. At sub-block 1226, the block 1220 may optionally include obtaining a SIB configuration from the third network entity. For instance, the SIB configuration may include one or more parameters to be included in a SIB or a SIB message.

In some implementations, the one or more SIBs may be DU-SIBs associated with the DU 430a. At sub-block 1230, the block 1220 may optionally include obtaining a SIB message from the second network entity or an indication that the second network entity can transmit the SIB message. For instance, the SIB message may be encoded by the DU 430a and may be stored at the DU 430a for later transmission.

In some implementations, at sub-block 1232, the block 1220 may optionally include requesting the one or more SIBs via a point-to-point interface or via a SBI. For instance, the network interface 730 may provide a point-to-point interface or SBI for carrying the SI config request 630 or 640.

In some implementations, at sub-block 1234, the block 1220 may optionally include subscribing to one or more network entities to notify the apparatus of any updates to one or more SIBs associated with the one or more other network entities.

In some implementations, at sub-block 1236, the block 1220 may optionally include obtaining the one or more SIBs from a network function or service that is responsible for generating the one or more SIBs. For instance, the network function or service may be one of: a purpose specific CU that is responsible for generating one or more SIBs for a type of UE or a type of communication; a system information service or a 6G network function; or a 6G RAN node in case of a non-split architecture.

In view of the above, the network entity 802 and/or the processor 710 executing the SIB management component 120 or the collection component 122 may provide means for obtaining, from one or more other network entities, the one or more SIBs.

At block 1240, the method 1200 includes requesting, after obtaining the one or more SIBs, a second network entity to transmit the one or more SIBs to the UE. In some implementations, for example, the network entity 702 and/or the processor 710 may execute the SIB management component 120 or the delivery component 126 to request, after obtaining the one or more SIBs, a second network entity to transmit the one or more SIBs to the UE. In some implementations, at sub-block 1242, the block 1240 may optionally include requesting the second network entity to transmit dedicated signaling to the UE based on an identifier of the UE, a system information type, and a cell or beam identifier where the SIBs are to be transmitted. In some implementations, at sub-block 1244, the block 1240 may optionally include requesting the second network entity to broadcast the one or more requested SIBs in a list of cells, beams, or areas. Accordingly, the network entity 802 and/or the processor 710 executing the SIB management component 120 or the delivery component 126 may provide means for requesting, after obtaining the one or more SIBs, a second network entity to transmit the one or more SIBs to the UE.

In some cases, rather than actually transmitting a message, a device may have an interface to output a message for transmission (a means for outputting). For example, a processor may output a message, via a bus interface, to a radio frequency (RF) front end for transmission. Similarly, rather than actually receiving a message, a device may have an interface to obtain a message received from another device (a means for obtaining). For example, a processor may obtain (or receive) a message, via a bus interface, from an RF front end for reception. In some cases, the interface to output a message for transmission and the interface to obtain a message (which may be referred to as first and second interfaces herein) may be the same interface.

Means for obtaining, means for outputting, means for requesting, means for subscribing, and/or means for notifying may include any of the various processors and/or memories shown in FIG. 3. Means for receiving and/or means for transmitting may include any of the various processors, memories, and/or transceivers shown in FIG. 3.

The following numbered examples provide an overview of aspects of the present disclosure:
Example 1. A method of wireless communication at a first wireless node, comprising: obtaining, from a second wireless node having a radio resource control (RRC) connection with the first wireless node, a request to transmit one or more system information blocks (SIBs) to the second wireless node; obtaining, from one or more other network nodes, the one or more SIBs; and requesting, after obtaining the one or more SIBs, a third wireless node to transmit the one or more SIBs to the second wireless node.
Example 2. The method of example 1, obtaining one or more SIBs comprises obtaining the one or more SIBs from a fourth wireless node that is a primary central unit for the third wireless node.
Example 3. The method of example 2, wherein the one or more SIBs include at least one SIB associated with the fourth wireless node, wherein obtaining the one or more SIBs comprises obtaining a SIB configuration from the fourth wireless node.
Example 4. The method of example 3, wherein obtaining the at least one SIB generated by the fourth wireless node comprises obtaining an identity of the fourth wireless node from the third wireless node, from a network repository function (NRF), or from another network function.
Example 5. The method of any of examples 1-4, wherein the one or more SIBs include at least one SIB associated with the third wireless node, wherein obtaining the one or more SIBs comprises obtaining a SIB message from the third wireless node or an indication that the third wireless node can transmit the SIB message.
Example 6. The method of any of examples 1-5, wherein the request to transmit one more SIBs is a dedicated uplink RRC message obtained via the RRC connection, an uplink media access control (MAC) control element (CE) received via the third wireless node, or a physical layer indication obtained via the third wireless node.
Example 7. The method of any of examples 1-6, wherein obtaining, from one or more other wireless nodes, the one or more SIBs, comprises requesting the one or more SIBs via a point-to-point interface or via a service based interface (SBI).
Example 8. The method of any of examples 1-7, wherein obtaining, from one or more other wireless nodes, the one or more SIBs, comprises subscribing to one or more wireless nodes to notify the first wireless node of any updates to one or more SIBs generated by the one or more other wireless nodes.
Example 9. The method of any of examples 1-8, wherein requesting the second wireless node to transmit the one or more requested SIBs to the second wireless node comprises requesting the third wireless node to transmit dedicated signaling to the second wireless node based on an identifier of the second wireless node, a system information type, and a cell or beam identifier where the SIBs are to be transmitted.
Example 10. The method of any of examples 1-9, wherein requesting the second wireless node to transmit the one or more requested SIBs to the second wireless node comprises requesting the third wireless node to broadcast the one or more requested SIBs in a list of cells, beams, or areas.
Example 11. The method of any of examples 1-10, wherein obtaining one or more SIBs comprises obtaining the one or more SIBs from a network function or service that is responsible for generating the one or more SIBs.
Example 12. The method of example 11, wherein the network function or service is one of: a service associated with a purpose specific CU that is responsible for generating one or more SIBs for a type of UE or a type of communication; a system information service or a 6G network function; or a service associated with a 6G RAN node in case of a non-split architecture.
Example 13. A method of wireless communication at a first wireless node, comprising: obtaining, from a second wireless node having a radio resource control (RRC) connection with a third wireless node that is different than a primary CU of the first wireless node, a request to transmit one or more system information blocks (SIBs) to the second wireless node; output the request to the third wireless node; obtain, from the third wireless node, an indication to transmit the one or more requested SIBs to the second wireless node; and output one or more messages including the requested SIBs for transmission to the second wireless node.
Example 14. The method of example 13, wherein the one or more requested SIBs include at least one SIB associated with a primary CU of the first wireless node, wherein the indication to transmit the one or more SIBs to the second wireless node includes the at least one SIB associated with the primary CU of the first wireless node.
Example 15. The method of example 13 or 14, wherein the one or more SIBs include at least one SIB associated with the first wireless node, the method further comprising: obtaining a request from the third wireless node for at least one SIB associated with the first wireless node; and outputting a SIB message for the at least one SIB associated with the first wireless node to the third wireless node.
Example 16. The method of example 15, wherein outputting the SIB message for the at least one SIB associated with the first wireless node to the third wireless node comprises outputting the SIB message via a point-to-point interface or via a Service Based Interface (SBI).
Example 17. The method of example 15, wherein outputting the SIB message for the at least one SIB associated with the first wireless node to the third wireless node comprises notifying the second wireless node of updates to one or more SIBs associated with one or more other wireless nodes.
Example 18. The method of any of examples 13-17, wherein the request to transmit one more SIBs is a dedicated uplink RRC message obtained via the RRC connection, an uplink media access control (MAC) control element (CE) received, or a physical layer indication.
Example 19. The method of any of examples 13-18, wherein outputting the one or more messages including the SIBs for transmission to the second wireless node comprises outputting dedicated signaling for transmission to the second wireless node based on an identifier of the second wireless node, a system information type, and an identifier of a cell, a beam, or an area included in the indication.
Example 20. The method of any of examples 13-19, wherein outputting the one or more messages including the requested SIBs for transmission to the second wireless node comprises broadcasting the one or more SIBs in a list of cells or beams included in the indication.
Example 21. The method of example 20, further comprising indicating to the second network entity whether the first wireless node was successful in broadcasting the one or more SIBs.
Example 22. A method of wireless communication at a first wireless node, comprising: outputting for transmission to a second wireless node, a request for one or more system information blocks (SIBs), wherein the first wireless node has a radio resource control (RRC) connection with a third wireless node that is not a primary central unit for the second wireless node; and obtaining the one or more SIBs from the third wireless node via dedicated signaling associated with the first wireless node.
Example 23. The method of example 22, wherein the request for one more SIBs is a dedicated uplink RRC message, an uplink media access control (MAC) control element (CE), or a physical layer indication.
Example 24 is an apparatus for wireless communications, comprising means for performing a method in accordance with any one of examples 1-12.
Example 25 is an apparatus for wireless communications, comprising means for performing a method in accordance with any one of examples 13-21.
Example 26 is an apparatus for wireless communications, comprising means for performing a method in accordance with any one of examples 22-23.
Example 27 is a non-transitory computer-readable medium comprising instructions that, when executed by a wireless node (e.g., network entity such as a CU), cause the wireless node to perform a method in accordance with any one of examples 1-12.
Example 28 is a non-transitory computer-readable medium comprising instructions that, when executed by a wireless node (e.g., network entity such as a DU), cause the wireless node to perform a method in accordance with any one of examples 13-21.
Example 29 is a non-transitory computer-readable medium comprising instructions that, when executed by a wireless node (e.g., UE), cause the wireless node to perform a method in accordance with any one of examples 22-23.
Example 30 is an apparatus for wireless communications, comprising: one or more memories, individually or in combination, having instructions; and one or more processors, individually or in combination, configured to execute the instructions and cause the apparatus to perform a method in accordance with any one of examples 1-12.
Example 31 is an apparatus for wireless communications, comprising: one or more memories, individually or in combination, having instructions; and one or more processors, individually or in combination, configured to execute the instructions and cause the apparatus to perform a method in accordance with any one of examples 13-21.
Example 32 is an apparatus for wireless communications, comprising: one or more memories, individually or in combination, having instructions; and one or more processors, individually or in combination, configured to execute the instructions and cause the apparatus to perform a method in accordance with any one of examples 22-23.
Example 33 is a wireless node (e.g., network entity such as a CU), comprising: one or more transceivers; one or more memories, individually or in combination, having instructions; and one or more processors, individually or in combination, configured to execute the instructions and cause the wireless node to perform a method in accordance with any one of examples 1-12, wherein the one or more transceivers are configured to: receive the request to transmit one or more SIBs to the UE.
Example 34 is a wireless node (e.g., network entity such as a DU), comprising: one or more transceivers; one or more memories, individually or in combination, having instructions; and one or more processors, individually or in combination, configured to execute the instructions and cause the wireless node to perform a method in accordance with any one of examples 13-21, wherein the one or more transceivers are configured to: receive the request to transmit one or more SIBs to the second wireless node; and transmit one or more messages including the requested SIBs.
Example 35 is a wireless node (e.g., UE), comprising: one or more transceivers; one or more memories, individually or in combination, having instructions; and one or more processors, individually or in combination, configured to execute the instructions and cause the wireless node to perform a method in accordance with any one of examples 22-23, wherein the one or more transceivers are configured to: transmit the request for one or more SIBs; and receive the one or more SIBs from the second network entity.

As used herein, a phrase referring to “at least one of” a list of items refers to any combination of those items, including single members. As an example, “at least one of: a, b, or c” is intended to cover: a, b, c, a-b, a-c, b-c, and a-b-c. Similarly, as used herein, a phrase referring to “one or more of” a list of items refers to any combination of those items, including single members. As an example, “one or more of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus for wireless communication, comprising:
one or more memories storing computer-executable instructions; and
one or more processors coupled with the one or more memories and configured to execute the computer-executable instructions, individually or in combination, to cause the apparatus to:
obtain, from a user equipment (UE) having a radio resource control (RRC) connection with the apparatus, a request to transmit one or more system information blocks (SIBs) to the UE;
obtain, from one or more other network entities, the one or more SIBs; and
request, after obtaining the one or more SIBs, a second network entity to transmit the one or more SIBs to the UE.

2. The apparatus of claim 1, wherein to obtain one or more SIBs, the one or more processors are configured to cause the apparatus to obtain the one or more SIBs from a third network entity that is a primary central unit for the second network entity.

3. The apparatus of claim 2, wherein the one or more SIBs include at least one SIB associated with the third network entity, wherein to obtain the one or more SIBs, the one or more processors are configured to cause the apparatus to obtain a SIB configuration from the third network entity.

4. The apparatus of claim 3, wherein to obtain the at least one SIB generated by the third network entity, the one or more processors are configured to cause the apparatus to obtain an identity of the third network entity from the second network entity, from a network repository function (NRF), or from another network function.

5. The apparatus of claim 1, wherein the one or more SIBs include at least one SIB associated with the second network entity, wherein to obtain the one or more SIBs, the one or more processors are configured to cause the apparatus to obtain a SIB message from the second network entity or an indication that the second network entity can transmit the SIB message.

6. The apparatus of claim 1, wherein the request to transmit one more SIBs is a dedicated uplink RRC message obtained via the RRC connection, an uplink media access control (MAC) control element (CE) received via the second network entity, or a physical layer indication obtained via the second network entity.

7. The apparatus of claim 1, wherein to obtain, from one or more other network entities, the one or more SIBs, the one or more processors are configured to cause the apparatus to request the one or more SIBs via a point-to-point interface or via a service based interface (SBI).

8. The apparatus of claim 1, wherein to obtain, from one or more other network entities, the one or more SIBs, the one or more processors are configured to cause the apparatus to subscribe to one or more network entities to notify the apparatus of any updates to one or more SIBs generated by the one or more other network entities.

9. The apparatus of claim 1, wherein to request the second network entity to transmit the one or more requested SIBs to the UE, the one or more processors are configured to cause the apparatus to request the second network entity to transmit dedicated signaling to the UE based on an identifier of the UE, a system information type, and a cell or beam identifier where the SIBs are to be transmitted.

10. The apparatus of claim 1, wherein to request the second network entity to transmit the one or more requested SIBs to the UE, the one or more processors are configured to cause the apparatus to request the second network entity to broadcast the one or more requested SIBs in a list of cells, beams, or areas.

11. The apparatus of claim 1, wherein to obtain one or more SIBs, the one or more processors are configured to cause the apparatus to obtain the one or more SIBs from a network function or service that is responsible for generating the one or more SIBs.

12. The apparatus of claim 11, wherein the network function or service is one of:
a service associated with a purpose specific CU that is responsible for generating one or more SIBs for a type of UE or a type of communication;
a system information service or a 6G network function; or
a service associated with a 6G RAN node in case of a non-split architecture.

13. The apparatus of claim 1, further comprising one or more transceivers configured to:
receive the request to transmit one or more SIBs to the UE, wherein the apparatus is configured as a network entity.

14. An apparatus for wireless communication, comprising:
one or more memories storing computer-executable instructions; and
one or more processors coupled with the one or more memories and configured to execute the computer-executable instructions, individually or in combination, to cause the apparatus to:
obtain, from a user equipment (UE) having a radio resource control (RRC) connection with a second network entity that is different than a primary CU of the apparatus, a request to transmit one or more system information blocks (SIBs) to the UE;
output the request to the second network entity;
obtain, from the second network entity, an indication to transmit the one or more requested SIBs to the UE; and
output one or more messages including the requested SIBs for transmission to the UE.

15. The apparatus of claim 14, wherein the one or more requested SIBs include at least one SIB associated with a primary CU of the apparatus, wherein the indication to transmit the one or more SIBs to the UE includes the at least one SIB associated with the primary CU of the apparatus.

16. The apparatus of claim 14, wherein the one or more SIBs include at least one SIB associated with the apparatus, wherein the one or more processors are configured to cause the apparatus to:
obtain a request from the second network entity for at least one SIB associated with the apparatus; and
output a SIB message for the at least one SIB associated with the apparatus to the second network entity.

17. The apparatus of claim 16, wherein to output the SIB message for the at least one SIB associated with the apparatus to the second network entity, the one or more processors are configured to cause the apparatus to output the SIB message via a point-to-point interface or via a Service Based Interface (SBI).

18. The apparatus of claim 16, wherein to output the SIB message for the at least one SIB associated with the apparatus to the second network entity, the one or more processors are configured to cause the apparatus to notify the second network entity of updates to one or more SIBs associated with one or more other network entities.

19. The apparatus of claim 14, wherein the request to transmit one more SIBs is a dedicated uplink RRC message obtained via the RRC connection, an uplink media access control (MAC) control element (CE) received, or a physical layer indication.

20. The apparatus of claim 14, wherein to output one or more messages including the SIBs for transmission to the UE, the one or more processors are configured to output dedicated signaling for transmission to the UE based on an identifier of the UE, a system information type, and an identifier of a cell, a beam, or an area included in the indication.

21. The apparatus of claim 14, wherein to output one or more messages including the requested SIBs for transmission to the UE, the one or more processors are configured to cause the apparatus to broadcast the one or more SIBs in a list of cells or beams included in the indication.

22. The apparatus of claim 21, wherein the one or more processors are configured to cause the apparatus to indicate to the second network entity whether the apparatus was successful in broadcasting the one or more SIBs.

23. The apparatus of claim 14, further comprising one or more transceivers configured to:
receive the request to transmit one or more SIBs to the UE; and
transmit one or more messages including the requested SIBs, wherein the apparatus is configured as a network entity.

24. An apparatus for wireless communication, comprising:
one or more memories storing computer-executable instructions; and
one or more processors coupled with the one or more memories and configured to execute the computer-executable instructions, individually or in combination, to cause the apparatus to:
output for transmission to a first network entity, a request for one or more system information blocks (SIBs), wherein the apparatus has a radio resource control (RRC) connection with a second network entity that is not a primary central unit for the first network entity; and
obtain the one or more SIBs from the second network entity via dedicated signaling associated with the apparatus.

25. The apparatus of claim 24, wherein the request for one more SIBs is a dedicated uplink RRC message, an uplink media access control (MAC) control element (CE), or a physical layer indication.

26. The apparatus of claim 24, further comprising one or more transceivers configured to:
transmit the request for one or more SIBs; and
receive the one or more SIBs from the second network entity, wherein the apparatus is configured as a user equipment.
